(19) United States
(12) Patent Application Publication
(10) Pub. No.: US 2007/0099167 A1
(43) Pub. Date: May 3, 2007

(54) Method and computer program for monitoring, tracking and enhancing a student performance

(76) Inventor: Terry James Eason, Terrell, TX (US)

Correspondence Address: Terry James Eason, 8612 Karen Lane, Terrell, TX, 75160, US

(21) Appl. No.: 11/592,647

(22) Filed: Nov. 3, 2006

Related U.S. Application Data
(60) Provisional application No. 60/732,960, filed on Nov. 3, 2005.

(51) Int. Cl. G09B 3/00

(52) U.S. Cl. 434/350

(57) ABSTRACT

A method and computer program are provided for monitoring, tracking and enhancing an educational performance of a student in one or more enrolled courses. The method and computer program including receiving student information including course information for one or more enrolled courses for a student in an educational institution, receiving course requirement information for each of the enrolled courses, receiving student monitoring criteria of the educational institution including one or more grading thresholds associated with the enrolled courses, periodically receiving student performance information for the student including testing results for the enrolled courses, periodically monitoring the student performance information including automatically determining whether the testing results are below the grading threshold associated with the enrolled course, and notifying the educational institution if the testing results are below the grading threshold associated with the enrolled course.

### CROSS REFERENCE TO RELATED APPLICATIONS

Pursuant to 35 U.S.C. § 119(e), the present document claims the benefit of the earlier filing date of co-pending U.S. provisional patent application Ser. No. 60/732,960, entitled “Method and Computer Program for Monitoring, Tracking and Enhancing a Student Performance,” filed in the U.S. Patent and Trademark Office on Nov. 3, 2005, hereby incorporated by reference, having a common inventor as the present document.

### BACKGROUND OF THE INVENTION

1. Field of the Invention

The present invention relates to enhancing student performance and more particularly, relates to a method and computer program for monitoring, tracking and enhancing a student's performance in an educational setting.

2. Discussion of the Background

A typical school (e.g., elementary school, middle school, high school, college or university) is responsible for overseeing many students and a typical school district is responsible for an even greater number of students. For instance, an individual school may have hundreds if not thousands of students attending that school during a given school year. Individual student performances are often difficult to monitor and track in such an educational setting due to the sheer number of students. An individual student's performance is sometimes overlooked until it is often too late to take corrective measures to improve that student's performance.

### SUMMARY OF THE INVENTION

Accordingly, one aspect of the present invention is to provide a method for monitoring, tracking and enhancing an educational performance of a student in one or more enrolled courses. The method including receiving student information including course information for one or more enrolled courses for a student in an educational institution, receiving course requirement information for each of the enrolled courses, receiving student monitoring criteria of the educational institution including one or more grading thresholds associated with the enrolled courses, periodically receiving student performance information for the student including testing results for the enrolled courses, periodically monitoring the student performance information including automatically determining whether the testing results are below the grading threshold associated with the enrolled course, and notifying the educational institution if the testing results are below the grading threshold associated with the enrolled course.

Another aspect of the present invention is to provide a computer program embodied in a computer readable medium for monitoring, tracking and enhancing an educational performance of a student in one or more enrolled courses. The computer program including a first computer code for receiving student information including course information for one or more enrolled courses for a student in an educational institution, a second computer code for receiving course requirement information for each of the enrolled courses, a third computer code for receiving student monitoring criteria of the educational institution including one or more grading thresholds associated with the enrolled courses, a fourth computer code for periodically receiving student performance information for the student including testing results for the enrolled courses, a fifth computer code for periodically monitoring the student performance information including automatically determining whether the testing results are below the grading threshold associated with the enrolled course, and a sixth computer code for notifying the educational institution if the testing results are below the grading threshold associated with the enrolled course.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1 is a flow chart illustrating the process of monitoring, tracking and enhancing a student's performance in an educational setting according to the present invention;

FIGS. 2A and 2B are flow charts further illustrating the process of monitoring, tracking and enhancing a student's performance in an educational setting according to the present invention;

FIG. 3 is a flow chart illustrating monitoring a student's performance in an educational setting according to the present invention;

FIG. 4 is a block diagram illustrating a student performance monitoring, tracking and enhancing system in an educational setting according to the present invention; and

FIGS. 5A-5C are block diagrams illustrating a web-based student performance monitoring, tracking and enhancing system in an educational setting according to one possible embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

The present invention provides a user with the ability to monitor, track and enhance a student's performance in an educational setting using an individualized plan to assist a student as the student progresses. The individualized plan is accessible to students, teachers, parents and school administers such that a student's performance may be monitored, tracked and enhanced. Functionally, the present invention may be separated into several modules. For example, the present invention may be functionally separated into progress, intervention, weakness, responsibilities, action plan, graduation plan, testing data, and print report modules.

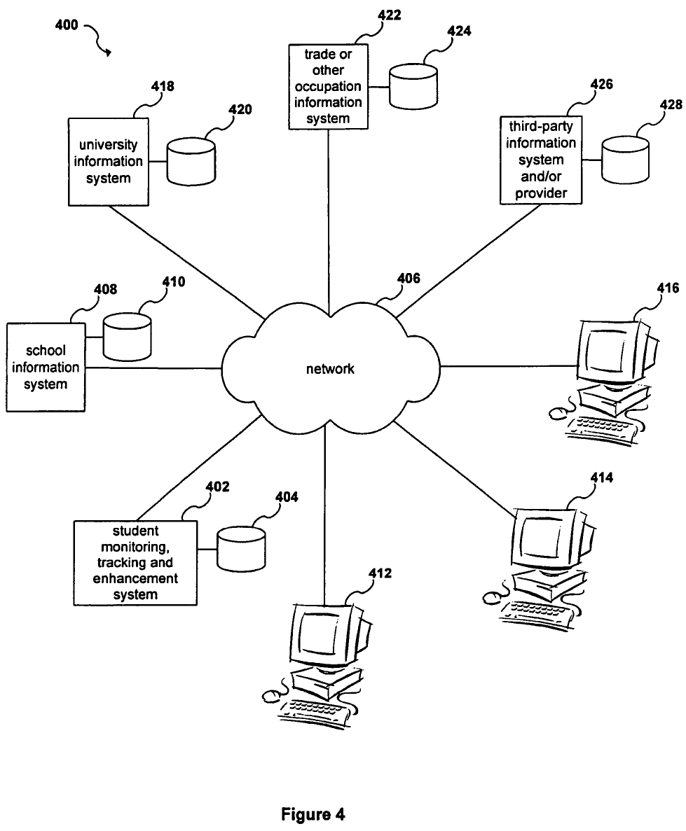

Referring to FIG. 4, a block diagram illustrating a student performance monitoring, tracking and enhancing system in an educational setting is shown. The present invention allows a counselor or administrator using a computer 412 or a teacher using a computer 414 to view, edit and print student monitoring, tracking and enhancement information stored on a student monitoring tracking and enhancement system 402 over a network 406. A student or parent using a computer 416 may optionally view and print the student monitoring, tracking and enhancement information. The network includes, but is not limited to, a local area network, a remote area network such as a dial-up network, a proprietary network, a wireless network, Internet or Intranet. In one embodiment, the student monitoring tracking and enhancement system 402 is a web based system in which a counselor or administrator using a computer 412, a teacher using a computer 414, or a student or parent using a computer 416 may access the web based system using a web browser over the Internet 406.

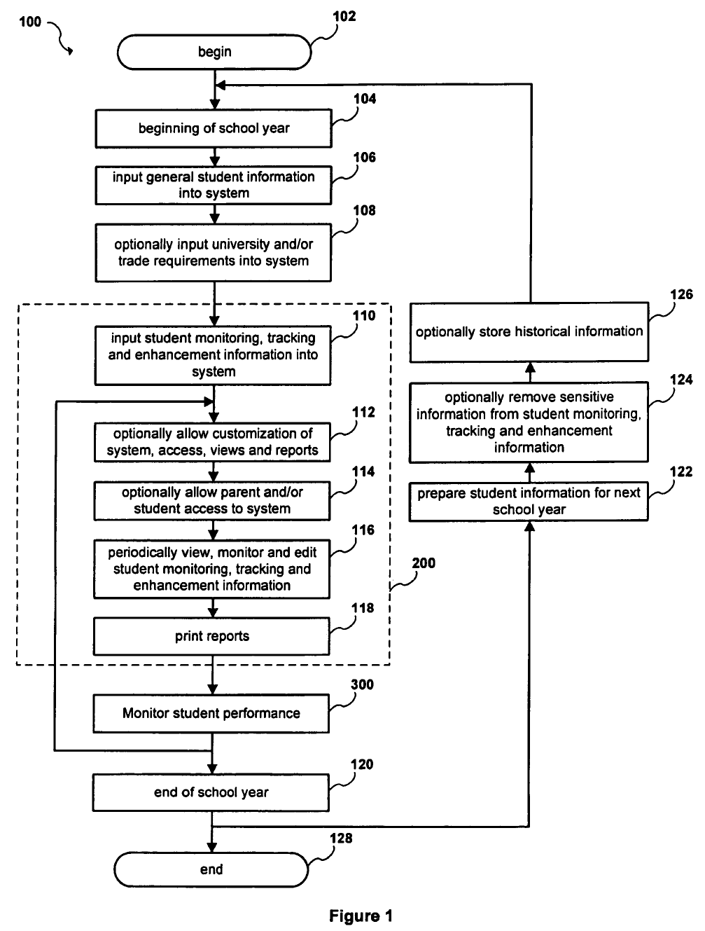

Referring to FIG. 1, a flow chart illustrating the process of monitoring, tracking and enhancing a student's performance in an educational setting is shown. The process begins preferably prior to the beginning of the school year and/or grading period, as shown at blocks 102 and 104. However, the present invention is not limited to any particular date and may reasonably begin on any date during the school year. At block 106, general student information for one or more students in a school system is input into the system. General student information includes, but is not limited to, information regarding the student's name, address, parents, ethnicity, age, or other pertinent student information. Block 106 may be accomplished either through manual entry or by extraction of data from a database. For instance, in one embodiment, one or more student records containing general student information are extracted, either manually or automatically, from a database 410 of a school information system 408 and then transferred into a database 404 of a student monitoring, tracking and enhancement system 402 via network 406, as shown in FIG. 4. The extraction process may optionally include a translation and/or reformatting of the one or more student records. The general student information may be transferred in any form including, but not limited to, ASCII file, proprietary database formats, xml, or the like. Optionally, the student monitoring, tracking and enhancement system 402 may be integrated into the school information system 408.

Optionally, at block 108, university and/or trade requirements are input into the system. University and/or trade requirements includes, but is not limited to, information regarding the courses that the university or trade require and/or recommend to be taken prior to entry into that university or trade. Block 108 may be accomplished either through manual entry or by extraction of data from a database or remote system. For instance, in one embodiment, one or more course requirements and/or recommendations are extracted, either manually or automatically, from a database 420 of a university school information system 418 and then transferred into database 404 of the student monitoring, tracking and enhancement system 402 via network 406, as shown in FIG. 4. The course requirements and/or recommendations may be transferred in any form including, but not limited to, ASCII file, proprietary database formats, xml, or the like. Likewise, the course requirements and/or recommendations may also be extracted from a database 424 of trade or other occupation information system 422, or from a database 428 of a third-party information system and/or provider 426. Optionally, the course requirements and/or recommendations may be periodically transferred over network 406 via an ftp server, http server, or other automated Internet transmission.

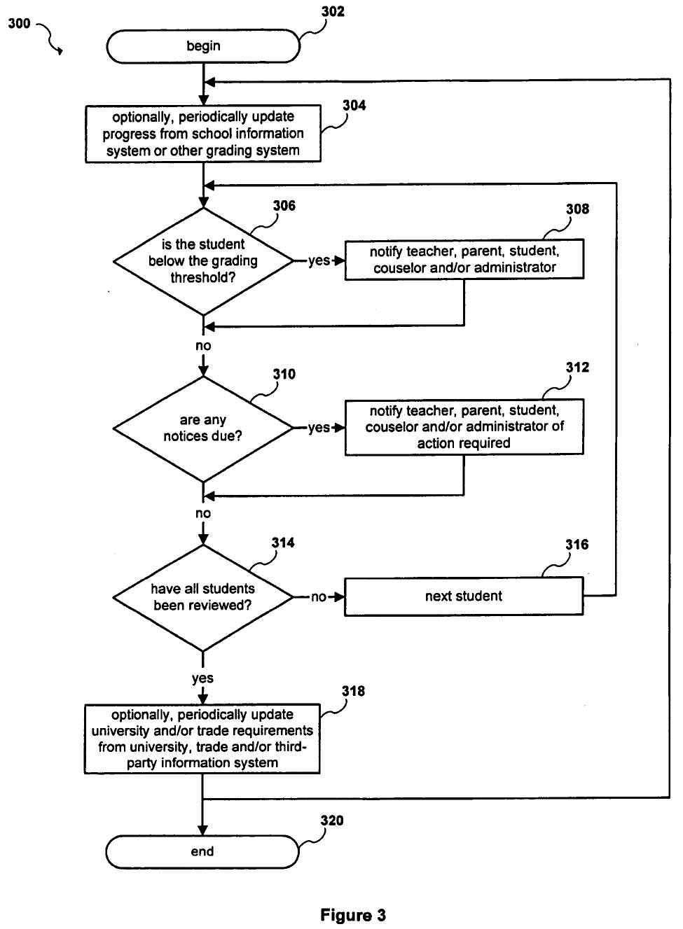

At block 110 student monitoring, tracking and enhancement information is input into the system. Optionally, the system, access, views and reports may be customized by the teacher and/or the counselor or administrator, at block 112. At block 114, one or more parents or students are allowed access to the system. Reports may be created in English and translated into another language including, but not limited to, Spanish. The teacher, counselor or administrator, and parent or student may periodically view and monitor the student monitoring, tracking and enhancement information, at block 116. The teacher and counselor or administrator may also edit this information. At block 118, teacher, counselor or administrator, and parent or student may print out one or more reports. Print reports include, but are not limited to, progress, intervention, weakness, responsibilities, action plan, and graduation plan reports. Reports may be presented in several forms including, but not limited to, text reports and graphical charts. Such charts are useful in graphically illustrating a student's performance over time individually or grouped with other students. Groupings with other students includes, but is not limited to, all or a portion of the students in a class, a school, a district. For instance, it might be useful to view students having similar educational, geographical or social backgrounds. At block 300, a determination is made as to whether any student is below a predetermined grading threshold or whether any notices are due for a student. In one embodiment, block 300 is performed by a computer program as shown in more detail in FIG. 3. Blocks 112-118 and 300 may be repeated periodically during the school year and/or grading period.

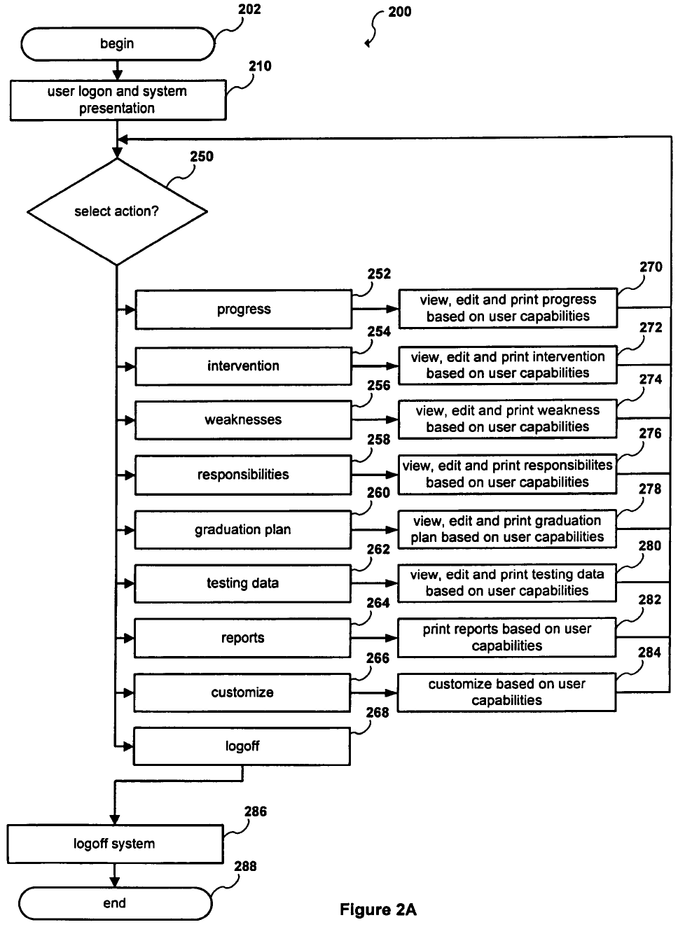

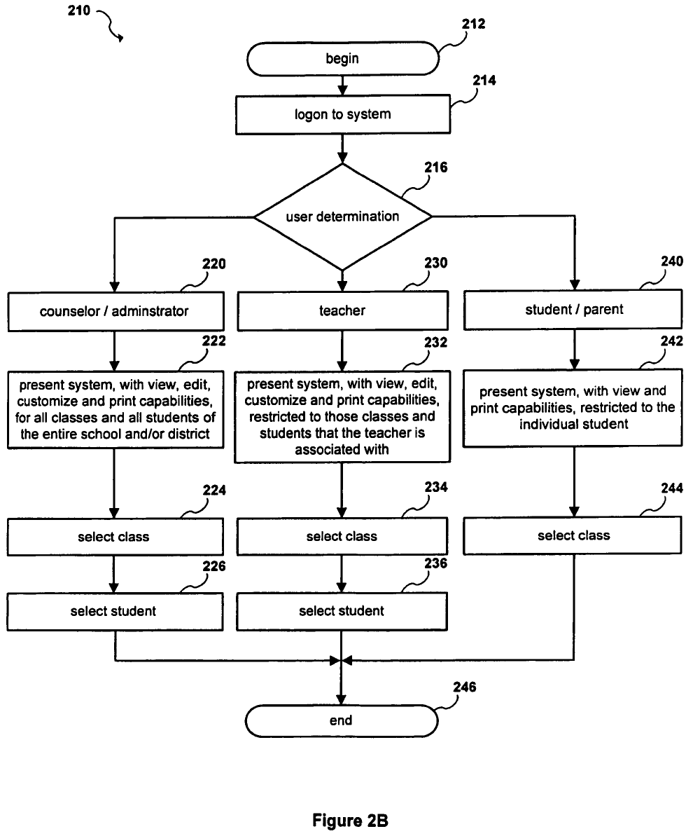

Referring to FIGS. 2A and 2B, flow chart further illustrating the process of monitoring, tracking and enhancing a student's performance in an educational setting is shown. At block 210, a user logs onto the system and the system is presented, as shown in more detail in FIG. 2B. At block 214, the user logs onto the system. At block 216, a determination is made as to whether the user is a counselor or administrator, a teacher, or a student or parent. If the user is a counselor or administrator, then the system is presented, with view, edit, customize and print capabilities, for all classes and all students of the school, at blocks 210 and 222. Optionally, all of the students of a school district may be presented. At blocks 224 and 226, a class and student are selected by the counselor or administrator. If the user is a teacher, then the system is presented, with view, edit, customize and print capabilities, restricted to those classes and students that the teacher is associated with, at blocks 230 and 232. At blocks 234 and 236, a class and student are selected by the teacher. If the user is a student or parent, then the system is presented, with view and print capabilities, restricted to the individual student, at blocks 240 and 242. At block 244, a class is selected by the student or parent.

At block 250, the user selects an action. The actions include, but are not limited to, progress, intervention, weakness, responsibilities, graduation plan, testing data, reports, customize views, respectively at blocks 252-266. At blocks 268 and 286, the user may also logoff the system. The user may view, edit and print the progress, intervention, weakness, responsibilities, graduation plan, testing data, reports, customize data, respectively at blocks 270-282. Optionally, the system, access, views and reports may be customized by the teacher and/or the counselor or administrator, at block 284.

Referring to FIG. 3, a flow chart illustrating monitoring a student's performance in an educational setting is shown. Optionally, at block 304, student grading information is updated from a school information system or other grading system. For instance, in one embodiment, one or more student records containing student grades are extracted, either manually or automatically, from a database 410 of a school information system 408 and then transferred into a database 404 of a student monitoring, tracking and enhancement system 402 via network 406, as shown in FIG. 4. The extraction process may optionally include a translation and/or reformatting of the one or more student records. The student grading information may be transferred in any form including, but not limited to, ASCII file, proprietary database formats, xml, or the like.

The student grading information may also include a predetermined grading threshold or other useful threshold for each student. Alternatively, the predetermined grading threshold or other useful threshold may initially be set by the teacher, counselor or other persons related to the school or district, and may periodically be adjusted manually or automatically. The threshold may periodically be adjusted automatically by the present invention based on factors including, but not limited to, testing data from other students in the classroom, school or district, and the student's own testing data. For instance, the threshold may periodically be adjusted to account for improved testing by the student and higher expectations related to such improved testing. The threshold may also periodically be adjusted to account for different graduation plans such as regular and advanced tracks.

At block 306, a determination is made as to whether a student is below the predetermined grading threshold or other useful threshold. If the student is below the threshold, then the teacher, parent, student counselor and/or administrator is notified, at block 308. The notification may be by any means including, but not limited to, email, instant electronic messaging, wireless text messaging, paging, alarming, postal mail, or the like. In one possible embodiment, the notification is sent to a parent via email and may include the following text:
Our records indicate that your child's school performance may be deficient. Information has been sent detailing the concerns we have for your child's success. Please review the contents.

At block 310, a determination is made as to whether any notices are due. For instance, a target date may be set for a particular action. If a notice is due, then the teacher, parent, student counselor and/or administrator is notified, at block 312. The notification may be by any means including, but not limited to, email, instant electronic messaging, wireless text messaging, paging, alarming, postal mail, or the like. The process continues to loop as shown at blocks 314 and 316 until all student records have been processed. Optionally, at block 318, university and/or trade requirements are input into the system, as previously discussed regarding block 108.

The progress module allows a user to maintain a student's progress over a fairly small period of time (e.g., every three, six or nine weeks) using incremental grades, grade averages and other notations that deal with an individual student's progress. For instance, the progress module may be configured to maintain a student's grade at the mid-point of a six week period, referred to as a 3-week progress report, along with the student's final grade average at the end of the six week period. An indication of whether the student returned a signed copy of the progress report to that student's respective teacher may also be maintained. Additional notes or other information for each individual teacher may also be maintained.

The intervention module allows a user to maintain prior academic intervention and/or detentions for each student. For instance, the intervention module may be configured to maintain any conferences that have been held by a teacher and a particular student and/or parent. A user is able to indicate whether the conference was a phone or personal conference, and the date that the conference was held. Documentation regarding detentions that have been assigned and/or attended may also be maintained. These detentions may be assigned to address academic needs, behavioral needs, and/or tutoring. In this area, the user is able to designate any contact that has been made with a counselor, assistant principal or other school administrator regarding the student. The user is able to designate the dates for each activity. Additional notes or other information for each individual teacher may also be maintained.

The weakness module allows a user to maintain the observed academic weaknesses of a student. For instance, the weakness module may be configured to indicate several possible student weaknesses including, but not limited to, whether the student: has completed assignments on time, has been inattentive in class, had excessive absences/tardies, had behavior problems, has been working below ability, has been sleeping in class, has prior low test grades, has reading problems, has not been organized, has not brought books to class, has not attended tutoring, or has not turned in make up work. Additional notes or other information for each individual teacher may also be maintained.

The responsibilities module allows a user to maintain whether a student has fulfilled his/her responsibilities as a student. For instance, the responsibilities module may be configured to indicate several possible student responsibilities including, but not limited to, when the student has: spoken with the teacher about his/her progress, spoken with parent about his/her progress, asked questions, attended tutorials, attended detentions, studied for tests, turned in their progress report, and/or kept up with their agenda. Additional notes or other information for each individual teacher may also be maintained.

The plan of action module allows a user to maintain a plan of action to make a particular student successful. For instance, the plan of action module may be configured to maintain a target date for academic success as well as an electronic signature of the teacher and student. Additional notes or other information for each individual teacher may also be maintained.

The graduation plan module allows a user to monitor short and long term individualized student performance. For instance, the graduation plan module may be configured to allow a particular student, parent, or counselor to choose a personalized graduation plan and class schedule for that student. A class schedule may be chosen based on an analysis of the student's individual needs. A historical record of the classes that were originally selected as well as the courses that were actually completed may be maintained. Thereby, as the student completes courses toward graduation, a step-by-step record of progress is available. The graduation plan monitoring may be configure to include, but is not limited to, regular and advanced tracks. The advanced track includes college prep courses including pre-AP and AP course.

Optionally, in one embodiment, one or more course requirements and/or recommendations are periodically extracted from a university school information system 418, trade or other occupation information system 422, or a trade or other occupation information system 422 directly into the graduation plan module. Thereby, the course selections offered by the graduation plan module are periodically updated to be optimized to a particular university, major, technology, or trade.

The testing data module allows a user to maintain historical testing data of students. The testing data includes, but is not limited to, TAKS, SAT, GRE, ACT, PSAT, AP, or the like. For instance, the testing data module may be configured to maintain TAKS scores for mathematics, reading, writing, social studies, and/or science. An indication of whether the student met the standard on the Texas Assessment Knowledge and Skills (TAKS) may also be maintained.

The testing data module allows a user to create a student report for some period of time. For instance, the testing data module may be configured to allow a user to create a daily, a three-week, six-week, or nine-week report. Multiple reports may be created based on the data needed to analyze an individual student or group of students. These reports include, but are not limited to, student progress, interventions, weaknesses, responsibilities, and TAKS data.

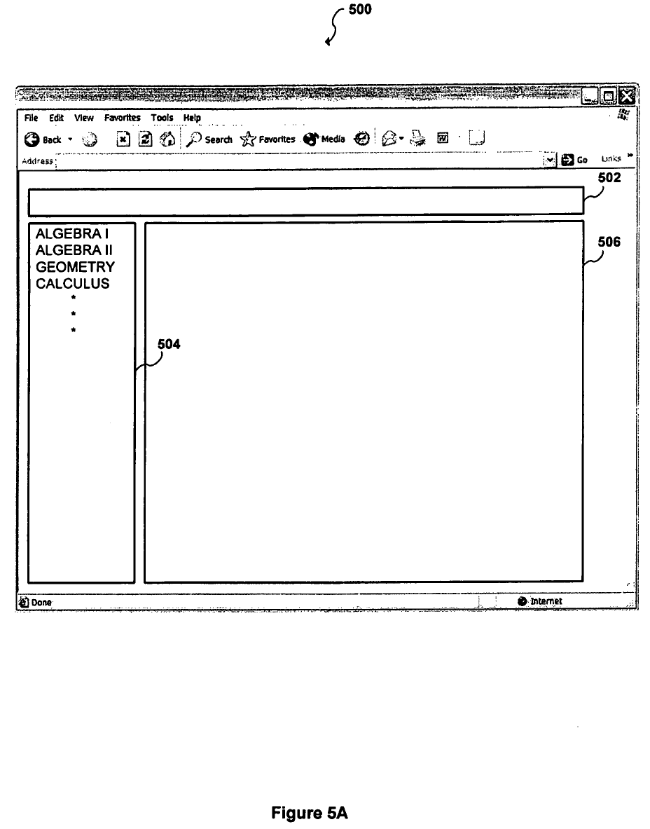

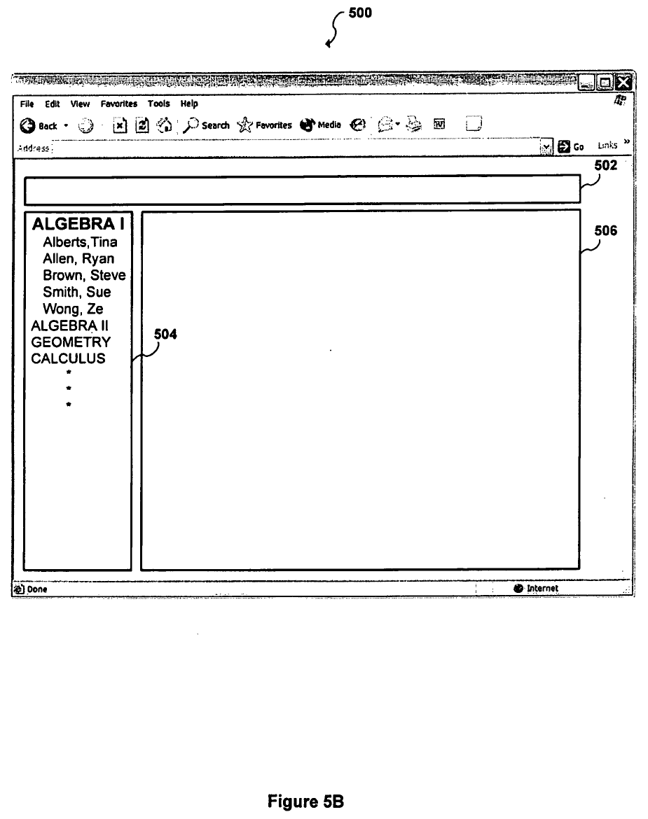

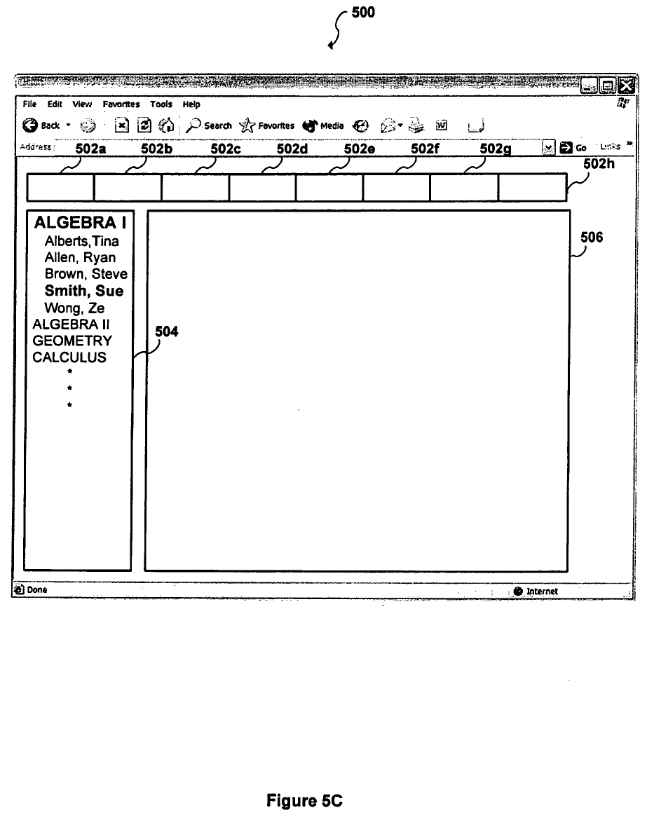

Referring to FIG. 5A-5C, block diagrams illustrating a web-based student performance monitoring, tracking and enhancing system in an educational setting according to one possible embodiment of the present invention are shown. According to this embodiment, superintendents, principals, curriculum directors, counselors, test directors, parents, teachers and/or students may be provided instant access to student performance monitoring, tracking and enhancing data anytime, anywhere using a web browser 500.

A user logon to the system with a web browser 500. An appropriate view is presented based on the type of user. For example, a teacher may initially be presented with a view of those classes, in block 504, that the teacher is associated with, as shown in FIG. 5A. The teacher selects a class (e.g., “ALGEBRA I”) from the classes shown in block 504 and is presented with those students associated with that particular class, as shown in FIG. 5B. The teacher selects a student (e.g., “Sue Smith”), as shown in FIG. 5C, and is presented with the individual student data for that particular student, in block 506. For each student, block 506 may include the student's name, grade level, address, parent's name, parent's e-mail address, and parent's phone number.

Menu 502 may be used to navigate the web-based system. For example, blocks 502a-502h may represent buttons and/or tabs identifying different modules including, but not limited to, “Progress,” “Intervention,” “Weakness,” “Responsibility,” “Plan of Action,” “Graduation Plan,” “Testing Data,” and “Print Report.” Menu 502 may also optionally include “Log Off” and “Configuration” buttons and/or tabs. As a user may select one of the buttons and/or tabs of menu 502 and then enter appropriate data according to the student's progress and/or needs.

Class set-up for the web-based student performance monitoring, tracking and enhancing system may be managed by any number of people including, but not limited to, outside technical specialists, on-campus data-controllers or other personnel. In one possible arrangement, student schedules and student data in a campus database may be uploaded from a district database, such that this information is readily available to teachers on the first day of school. As student schedules change, the counselor's office may be responsible for reflecting changes in the teacher roster of the system. Teachers may enter and save individual student data as the student performs in the a particular class. Thereafter, administrators, counselors, parents, and/or students may be allowed access to a student's progress. Teachers may use the system to enter data regarding an individual student's progress, intervention, weakness, responsibilities, and plan of action. Counselors may use the system to enter data regarding the student graduation plan.

The present invention may be configured to be used at any education level or educational setting including preschool, elementary school, junior high school, high school, college, university and/or trade school.

The processes and mechanisms set forth in the present description may be implemented using a conventional general purpose microprocessor, or silicon as part of a graphics accelerator chip and/or subsystem, programmed according to the teachings in the present specifications, as will be appreciated to those skilled in the relevant art. Appropriate software can be prepared based upon the teachings of the present disclosure, as will also be apparent to those skilled in the relevant arts.

The present invention thus includes a computer program which may be hosted on a storage medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A method for monitoring, tracking and enhancing an educational performance of a student in one or more enrolled courses, comprising:
receiving student information for a student in an educational institution, wherein the student information includes course information for one or more enrolled courses of the student;
receiving course requirement information for each of the enrolled courses;
receiving student monitoring criteria of the educational institution, wherein the student monitoring criteria includes one or more grading thresholds associated with the enrolled courses;
periodically receiving student performance information for the student, wherein the student performance information comprises testing results for the enrolled courses;
periodically monitoring the student performance information, wherein the monitoring comprises automatically determining whether the testing results are below the grading threshold associated with the enrolled course; and
notifying the educational institution if the testing results are below the grading threshold associated with the enrolled course.

2. A method of claim 1, wherein the student performance information further comprises at least one of a progress module, an intervention module, a weaknesses module, a responsibilities module, and a graduation plan module.

3. A method of claim 1, wherein the monitoring is automated using computer software.

4. A method of claim 1, wherein the student information has a predetermined format, and wherein receiving student information comprises:
extracting information from one or more student records; and
translating the information into the predetermined format.

5. A method of claim 4, wherein the student information is extracted from a group consisting of an ASCII file, a proprietary database format and XML.

6. A method of claim 1, wherein the notifying the educational institution comprises notifying at least one of a teacher, counselor, and administrator of the educational institution.

7. A method of claim 1, further comprising notifying a parent of the student if the testing results are below the grading threshold associated with the enrolled course.

8. A method of claim 7, wherein the educational institution notification and the parent notification are by email.

9. A method of claim 1, further comprising generating reports associated with the student performance information.

10. A method of claim 9, the reports comprise at least one of a chart and text report.

11. A method of claim 1, wherein the monitoring further comprises viewing the student performance information over a computer network.

12. A method of claim 2, further comprising periodically adjusting one or more of the grading thresholds.

13. A method of claim 12, wherein the grading thresholds are adjusted based on student performance information of other students in one or more of the enrolled courses.

14. A method of claim 12, wherein the grading thresholds are adjusted based on improved testing results of the student.

15. A method of claim 12, wherein the grading thresholds are adjusted based on the graduation plan information.

16. A method of claim 2, wherein the progress module comprises incremental grades and grade averages of the student over a short period of time.

17. A method of claim 2, wherein the student performance information further comprises teacher notations and recommendations.

18. A method of claim 17, wherein the intervention module comprises behavior information and academic interventions and detentions for the student.

19. A method of claim 17, wherein the graduation plan module comprises the course information for the enrolled courses and the track of the student.

20. A computer program embodied in a computer readable medium for monitoring, tracking and enhancing an educational performance of a student in one or more enrolled courses, the computer program comprising:
a first computer code for receiving student information for a student in an educational institution, wherein the student information includes course information for one or more enrolled courses of the student;
a second computer code for receiving course requirement information for each of the enrolled courses;
a third computer code for receiving student monitoring criteria of the educational institution, wherein the student monitoring criteria includes one or more grading thresholds associated with the enrolled courses;
a fourth computer code for periodically receiving student performance information for the student, wherein the student performance information comprises testing results for the enrolled courses;
a fifth computer code for periodically monitoring the student performance information, wherein the monitoring comprises automatically determining whether the testing results are below the grading threshold associated with the enrolled course; and
a sixth computer code for notifying the educational institution if the testing results are below the grading threshold associated with the enrolled course.
